(19) United States
(12) Patent Application Publication
(10) Pub. No.: US 2007/0043612 A1
(43) Pub. Date: Feb. 22, 2007

(54) Method for providing regular audiovisual and marketing content directly to consumers

(75) Inventors: Kay Koplovitz, New York, NY (US); Marla Ginsburg, Calabasas, CA (US); Mathieu Missoffe, Paris (FR)

Correspondence Address: SUGHRUE MION, PLLC, 2100 PENNSYLVANIA AVENUE, N.W., SUITE 800, WASHINGTON, DC, 20037, US

(73) Assignee: TVD: Direct to Consumer Entertainment, LLC

(21) Appl. No.: 11/206,213

(22) Filed: Aug. 18, 2005

(51) Int. Cl. G06Q 30/00

(52) U.S. Cl. 705/14

(57) ABSTRACT

A direct content delivery method, intended for directly delivering regular audiovisual and marketing content to consumers, includes regularly providing a delivery component having audiovisual content, marketing content, and backchannel connection information. The delivery component may be directly physically or directly electronically distributed to consumers. Consumers view the audiovisual content but may not avoid the marketing content. Consumers are drawn to the high quality audiovisual content, which may be episodic in nature. A backchannel connection arrangement, correlated to the backchannel connection information, implements a two-way direct communication path.

### BACKGROUND OF THE INVENTION

1. Field of the Invention

The field of the invention is the delivery of audiovisual and marketing content from product and service marketers directly to consumers.

2. Background Information

As media markets continue to fractionalize, product and service marketers experience increasing difficulty in reaching their desired target consumers through the various traditional media.

The ever increasing number of television channels available to the audience in a digital world, coupled with the multiplication of devices through which entertainment and information can be accessed and perused (e.g., television, computer, cell phone, videogame player, personal video recorder) have created a pressure on marketers to efficiently locate their target consumers and aggregate them on a scale that suits their marketing needs.

Challenged in ratings, broadcast television is now equally challenged in its position as a dominant solution to any and all marketing and communication needs. Marketers are now asking for innovative and holistic communication solutions, as well as for economics sounder than the traditional approach of thirty second television spots. Such spots have consistently increased in cost, although broadcast television has decreased in ratings in the past years.

Moreover, with consumers being exposed to an ever increasing number of marketing messages every day through multiple channels and vehicles, there has been a growing concern over consumers' lack of attention, and over marketing efficiency in general. This concern is widely supported by studies demonstrating the decreasing efficiency of marketers' communication in media environments that are now beyond cluttered by marketing messages.

These phenomena of impact dilution and advertising avoidance, and their potential consequences for marketers, are made even more acute by the constant rise of personal video recorders in consumer households; such devices allow viewers to fast forward through advertising messages, a feature which has proved extremely popular among the current established user base and already poses a threat to established communication plans that heavily rely on televised advertising spots.

Within the above described paradigm, marketers are aggressively seeking new and complementary solutions to reach consumers. While a number of potential solutions have been identified using traditional media and implemented with mixed results, a need still exists for marketers to touch consumers directly and more effectively, outside of existing communication channels.

3. Related Art

Prior attempts in this field of endeavor have been unsatisfactory.

One such attempt is shown in the published U.S. patent application US20020165797A1 of Deitrickson, entitled “Interactive on-line marketing method involves loading compact disk into computer to provide link to internet site for enabling purchase of merchandise.” This system provides for accessing music videos and other products related to the artist whose links are provided in the promotional CD. A problem with this approach is that it is limited to selling music and music-related merchandise and does not provide for a global solution to take advantage of integrated DVD- and on-line marketing potential to establish a solid relationship with consumers. In addition, said patented system merely relies on existing sampled content to promote a given CD or artist (i.e., parts of songs already known through other sources such as radio and the like), instead of leveraging the creation of exclusive, original content to build a real “channel” that will be attractive enough to the consumer and generate long-term following.

Another approach is shown in the published U.S. Pat. No. 6,188,398 of Collins-Rector et al., entitled “Product and service advertising using web page, involves synchronizing advertisement with video and displaying thumbnail version of replaced advertisement in tool bar”. This method allows the displaying of targeted advertising at predetermined times while a video is watched on the Internet. This system is limited in scope: while it does offer a targeted advertising experience on the Internet, it does not address the current requirement to combine multiple touch points (packaging, DVD, on-line etc . . . ) and multiple forms of advertising and promotions (product placement, video spots, interactive, contests etc . . . ) to design a truly effective communication strategy.

Another approach is shown in the published U.S. patent applications US20020040329 of Cohen et al. and US 20050021903 of Baxter. Both of these systems allow users to access on-demand product information (so called “telescopic” ads) and/or to purchase a product or service while watching a DVD-based video featuring said product or service in its content. This approach takes advantage of DVD's interactivity and connectability but does not constitute a true solution to improve general marketing efficiency in the short term: in addition to the uncertainty surrounding consumer behaviors which have yet to evolve to make such a system effective at the right scale, it fails to see the advantage of relying on a content-based strategy to make sure the DVDs—and the associated marketing content—get watched on an on-going basis. In these approaches, no regular, exclusive release of entertainment content is contemplated and therefore on-going interest in the content cannot be achieved.

Another approach tries to add similarly non-intrusive on-demand advertising to live video programming, by allowing users to access complementary product information and advertising when prompted during a show. Such an approach is described under different forms in the U.S. Pat. No. 6,615,408 of Kaiser et al., application US20020059590 of Kitsukawa et al., and U.S. Pat. No. 5,903,816 of Broadwin et al. The two main problems with this approach is that, contrary to the present invention, it still depends on the broadcast model where numerous advertisers compete for the attention of an increasingly ad-avoiding audience, and that it involves a significant shift in consumer behaviors since it has them switch away from their program to the advertising content for an undetermined duration.

Another approach is shown in the published U.S. patent application US20030028888 of Hunter et al., entitled “Updated advertisement provision method involves displaying advertisement during, before or after display of entertainment content”. This system involves a player device allowing the reading of content on a pre-recorded medium, intersected by the reading of “un-skippable” advertisement units from a second pre-recorded medium. The major problem with this approach is that it is based on custom hardware technology, which involves the mostly impractical use of two mediums (one for content and the other for advertisement) and should prove very difficult if not impossible to impose as a mass-market standard in the current environment.

As disclosed in the published U.S. patent applications US20030192060 of Levy, US20040028226 of Saar et al., US20030154128 of Liga et al., US20010049820 of Barton, US20030149621 of Shteyn, US20040133909 of Ma, and US20040268384 of Stone, various systems and methods have been developed to help marketers improve marketing efficiency by controlling ad-skipping, encouraging ad-seeing and/or enhancing ad-targeting on Digital Video Recorders and other time-shifting digital devices. Unfortunately such systems and methods are limited to the current established DVR user base which makes them unsuitable for use as short-term large scale marketing innovations.

Another approach is shown in the published U.S. patent application US20040098449 of Bar-Lavi et al., entitled “Server and client communication method for targeting advertisement over communication network e.g. Internet, involves installing communication module in computer based upon playback of music program”. This system allows a user to access on a computer targeted content and ads based on his or her profile. The problem with this approach is in the development of a custom browser that may become an impediment to the wide spread of that technology. In addition, it is restricted to accessing content on-line versus on TV or home video medium, and thus is still limited to computer-savvy target demographics and to short video vignettes depending on available bandwidth.

Another approach is shown in the published U.S. patent application US20040148424 of Berkson et al., entitled “Bundled digital media content file stores primary advertisement content which is played, based on header information, before playing primary media content in player”. This system allows to force a user to watch advertising or promotional content before being able to access a downloaded piece of media content. The problem with this system is that it is limited to content that is download-able on-line and will require a new custom-made program or plug-in to unbundle downloaded files and possibly to play the content.

Another approach is shown in the published U.S. patent application US20050015267 of Barringer et al., entitled “Entertainment sponsorship marketing system using movie, incorporates product into storyline such that a series exists between business operation and product, to facilitate resolution of certain issues related to business operation”. This product placement-type system allows integrating a given product into the storyline of a television show, so as to leverage said show and associated marketing channels (such as the internet) to promote and advertise the product in an impactful and innovative manner. The major problem with this system is the implied development and production of a television show in association with a broadcast partner: as demonstrated by recent examples of similar endeavors, high entry prices, rising conflicts of interest and increasingly fickle audience make it a risky play.

Another approach is shown in the published U.S. patent application US20030190961 of Seidman, entitled “A DVD for advertising a product or service carries an advertisement together with a game related to the advertisement for which prizes are offered”. This system provides advertising in the form of a DVD mixing in promotional content, a game and a contest with prizes. Such a system risks being not attractive enough to users if the DVD content is limited to existing advertisement versus original entertainment or informative content. It is limited in scope and fails to include provisions for on-line feedback or serialized content, such as a series of games etc.

Another approach is shown in the published U.S. patent application US20040019521 of Birmingham, entitled “Product and service advertising medium e.g. compact disk for restaurant, has instructions to provide metadata associated with establishments and coupons for discounted product or service at listed establishments”. This approach involves a DVD-based catalogue including listings of establishments, that can be searched and viewed. While this approach uses some of best known features of DVD technology (multimedia, searchability etc . . . ), it is limited to compiling existing raw data (similarly to the yellow pages listings) and does not rely on regular releases of original entertainment to help build a real communication channel.

Another approach is shown in the U.S. Pat. No. 6,698,020 of Zigmond et al., entitled “Advertisement inserting method in home entertainment system such as television”. This system allows a set top box to insert relevant advertising inside television programming, based on the demographic and geographic profile of each household. This approach ensures some relevance at the household level but cannot precisely determine who really is in front of the TV at any given time. In addition, it is still based on the traditional model of aggregating advertising spots in-between programming and hardly offers any solution to help marketers break out of the clutter of competing ads.

Another approach is shown in the published U.S. patent application US20040204996 of Miralles et al., entitled “Fundraising and marketing method, involves contacting merchant to get advertising content with merchandise and service discounts and offers, and converting content into electronic format advertising to store on credit-card CD-ROM”. This approach takes advantage of the multimedia potential of CD-Roms to present traditional coupons and other offers on a more compelling direct marketing vehicle. However, this approach is still limited to a collection of advertising and promotional content, and fails to include any original content to make the delivered medium into a truly compelling proposition for its recipients.

In view of the foregoing problems and the deficiencies in prior approaches, there exists a need for an improved approach that provides a new, direct channel by which marketing content can be provided to consumers.

### SUMMARY OF THE INVENTION

One of the invention's objectives, among others, is to satisfy the above-mentioned long-felt, but unsatisfied need for a solution to the foregoing problems. In particular, an embodiment of the invention provides marketers the ability to take the problem of media and communication efficiency into their own hands. An embodiment of the invention effectively integrates several components which will allow marketers to leverage their own direct access to consumers (e.g., through stores, packaging, direct mail, internet, partnership with third parties) into a new, fully effective, direct, two-way communication channel to complement other existing media. According to different embodiments of the invention, such a direct two-way communication channel can be developed and implemented to simultaneously serve the needs of even several marketers.

An embodiment of the invention is realized in a method of directly delivering regular audiovisual and marketing content to consumers using a combination of off-line (e.g., DVD) and on-line (e.g., broadband internet, VOD) components, coupled with a response back channel (“backchannel” hereafter) allowing two-way communication with users. It is also realized in the concrete development and implementation of such off-line and on-line components and backchannel.

The manner in which the above-identified objectives and others are realized will become apparent by way of the following description of exemplary embodiments, taken in conjunction with the enclosed drawing figures.

### BRIEF DESCRIPTION OF THE DRAWINGS

FIG. 1 graphically depicts a method according to an embodiment of the invention.

FIG. 2 depicts various agents involved in the development and implementation of one embodiment of the invention where multiple marketers are involved, and one primary marketer implements the communication channel.

FIG. 3 depicts various agents involved in the development and implementation of another embodiment of the invention where a single marketer uses the invention to the benefit of one or more of its own brands.

FIG. 4 shows, in simplified form, a delivery component having audiovisual content and marketing content.

FIG. 5 depicts one approach to implementing a backchannel arrangement.

### DETAILED DESCRIPTION OF THE PREFERRED EMBODIMENTS

In the above-identified drawing figures, and in the description here, it is assumed that the reader is already thoroughly familiar with the technical aspects of this field of endeavor. Readers desiring to learn more about the underlying technology are invited to consult the documents mentioned in the “Related Art” section, above. Therefore, unnecessary details have been omitted from both the drawing figures and the description so as to avoid obscuring the invention. Furthermore, it will be appreciated that the invention is taught herein by way of some examples, but that the invention is not limited to just the disclosed examples and has a scope defined by the appended claims.

The invention resides, in one embodiment, in a method to develop and implement a direct two-way communication channel between product and service marketers and consumers, in the concrete development and implementation of all of the method's components (including but not limited to the off-line and/or on-line components necessary to the delivery of audiovisual and marketing content, the audiovisual and marketing content, and the backchannel necessary to provide consumers with additional response and interaction potential).

Terms Used In This Description In A Special Way.

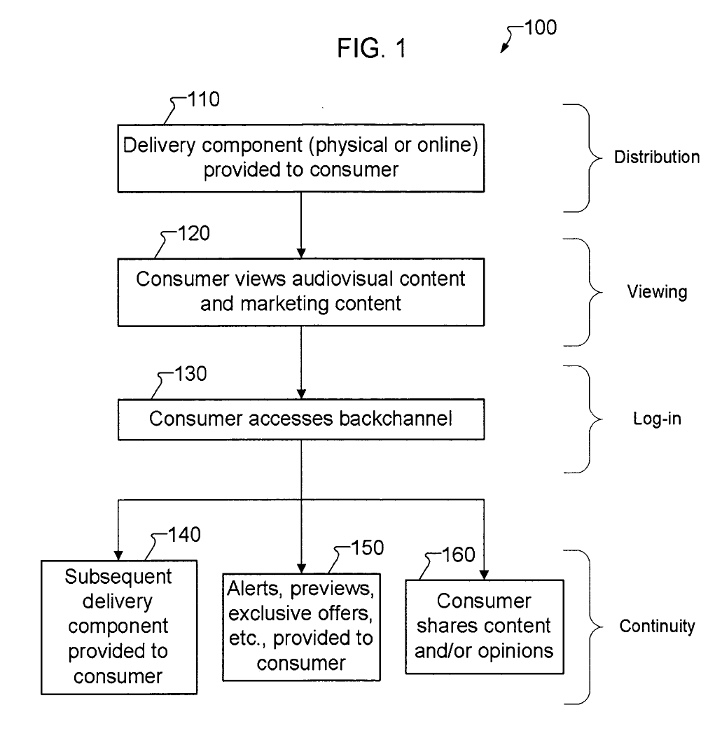

“Consumers”, as used herein, is meant to refer to targeted persons interacting with the implemented system at any of the stages described in FIG. 1. This includes primary targeted consumers who are made to enter in contact with the system as well as “secondary” consumers who are subsequently exposed to it through collective viewing and/or sharing. As shown in FIG. 1, consumers may get involved with the system in several different ways. The system thus may include (1) the distribution 110 of a delivery component to consumers, (2) the viewing 120 of audiovisual and marketing content carried by such a delivery component, (3) the use 130 of a backchannel by consumers to complete certain actions, (4) and the repeat 140 of steps 1-3 for each regular content release, promoted 150 and encouraged 160 through various means.

Regular content release can be understood to include the release of content on a periodic basis, such as weekly or monthly. It may also be understood that the release of content occurs on the basis of events that do not occur with periodicity, but are frequent enough to suit the marketer's marketing objectives.

The term “Direct Two-way Communication Channel” is used herein to describe the system's dual features of regularly delivering 110 audiovisual and marketing content and also allowing consumers' response and participation 130 through a backchannel. This aspect is one manner in which the present embodiment is distinguished from one-time marketing initiatives. The “Direct” delivery of content is another distinguishing aspect of the present embodiment. As used herein, “direct” delivery means delivery by other than the traditional media channels (e.g., broadcasters, cable operators and channels, radio stations), although in some instances, partnering with such traditional players (e.g., magazines) may be helpful to reach certain audiences. Depending on whether the delivery component is off-line (e.g., DVD) or on-line (e.g.; broadband internet, VOD), the “direct” distribution methods may include, but are not limited to: in-store give-aways, packages, direct mail, internet, or partnership with third party distributors. It should also be understood that although the direct channel will be separate from the traditional media, some or all traditional media may be used to raise consumers' awareness of the direct channel.

The “Delivery Component” shall be understood as any and all vehicles, physical or not, portable or not, readable by any home appliance or computer or both, which may “carry” in the broadest sense the appropriate audiovisual and marketing content.

For most preferred embodiments of the invention, one will differentiate between two types of delivery components. On the one hand, physical off-line vehicles (such as, but not limited to, DVD-Video, DVD-Audio, DVD-ROM, CD-ROM, CD, SVCD, VCD, CVD, HD-DVD, Blu-Ray Disc, UMD and any other new or derivative technology that may exist now or be developed in the future) will be “imprinted” with the content and be physically distributed to consumers, who will then read them through the appropriate devices. On the other hand, on-line conduits such as broadband internet, whether through DSL, wireless or cable technology, and any other Video-On-Demand platform (e.g., digital cable and satellite, third generation wireless telephony), may make content available to consumers through a variety of playing devices, whether through a server host or peer-to-peer technology.

The initial choice of one of the above described delivery components should not be construed as definitive or exclusive of others; in various embodiments of the invention it is expected that several delivery components will be developed and implemented, whether in a consecutive (e.g., a DVD-based component giving way to an on-line VOD component when VOD penetration allows it, or a DVD-Video being replaced by a HD-DVD upon maturing of the new technology) or co-existent manner (e.g., from the outset both a DVD-based component and a broadband internet component for early adopters).

As used herein, the term “Audiovisual Content” may include any type of programming unit using any combination of video, still image, text and sound towards entertaining and/or informative purposes. Such combination of video, still image, text and sound will be considered audiovisual content for the invention without any restriction to the format, duration, genre, subject matter or technical specifications of the audiovisual programming. Such audiovisual content may also be understood to include interactive content under all its forms (e.g., from basic clickable functions to actual video-game) depending on the delivery component's technical features. The audiovisual content may be split in any number of separate units, independent or not from each other, and may include functionalities to encourage consumers to browse through as many of the units as possible. For example, certain content units may be “locked” or “hidden” and accessible only after consumers have watched other audiovisual or marketing content units, or a contest attached may encourage the search for clues throughout the audiovisual and marketing content in order to win attached prizes.

One of the purposes of the invention is to leverage the emotional impact of the above described audiovisual content to more efficiently convey “Marketing Content” along with it, whether existing or specially developed for the purpose of implementing the invention. While marketing content may include any combination of video, still image, text and sound, it will be appreciated that marketing content has a marketing purpose, as opposed to the entertainment and/or informative goals of audiovisual content. Thus “Marketing Content” shall be herein understood to include any and all efforts undertaken by marketers to convey marketing messages about products and/or services to consumers. Depending on the chosen delivery component, marketing content may include but not be limited to advertising spots (all lengths, video or radio), any form of programming sponsorship, sweepstakes, infomercials, branded entertainment under all its forms, interactive advertising such as so-called telescopic ads and “advergames”, dedicated websites and other TV-to-Web operations (whereby the audience is lead from programming accessed on television to a website to complete certain actions). The above described types of marketing content will be considered without any restriction to their format, duration, and/or technical specifications, as well as without any restriction to the type of product or service they relate to. The marketing content included on a delivery component may also include fully functional commerce platforms (e.g., integrated e-commerce site) allowing consumers to directly buy any product or service in the course of their viewing of the audiovisual content.

It will be understood that audiovisual and marketing content may be combined in some instances in an effort to provide additional efficiency and effectiveness in marketing communication (e.g., branded entertainment, infomercials, TV-to-Web), so that the line separating the two types of content may not always be clearly defined.

In an effort to encourage feed back and participation from consumers, both audiovisual and marketing content may be split in some instances between the delivery component and the backchannel. For example, a piece of programming on a DVD may prompt consumers to log-in on a web site to watch the end on-line. Likewise, a commercial sweepstake operation may involve looking for clues across the DVD and going on-line subsequently to complete a riddle and enter for a chance to win a prize. The backchannel may advantageously be used to collect quantitative data as well as qualitative feed back from interacting consumers, within the constraints of applicable privacy laws and rulings. The backchannel may also be used to send additional information to consumers in-between content releases, as well as to promote and encourage consumers' sharing of opinions on the content and of the content itself, within the constraints of applicable trademark and copyright laws and rulings.

Although other more traditional paths such as “1-800 numbers” and fill-in paper forms may be elected for use on occasion, the vast majority of embodiments of the invention will see their backchannel handled on-line through the internet (through any combination of email and web site features, including but not limited to forums, so-called “chat” functions, interactive games, contest participation, quizzes and log-in forms, as well as other internet-based application involving user-created content such as newsgroups and peer-to-peer) or through any two-way platforms with similar features (such as two-way VOD when it becomes widely available on digital cable and satellite for instance). Thus, depending on the cases, the delivery component and backchannel may either be accessed by consumers through different devices (e.g., reading a DVD-Video on a television set and going on-line through a separate home computer) or through an integrated device (e.g., VOD content accessed through the internet which also allows direct feed back, or even the DVD-ROM section of a DVD-Video played on a computer which allows direct access to the internet when reading the DVD-ROM).

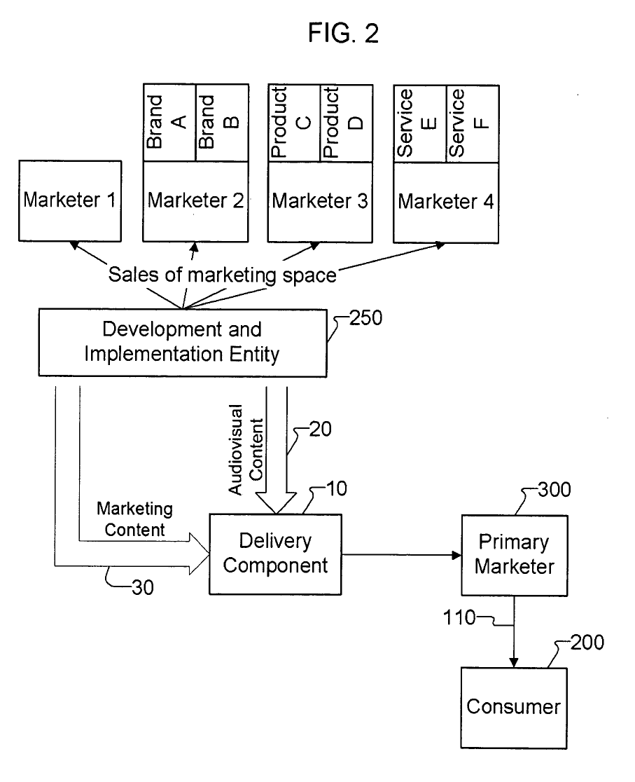

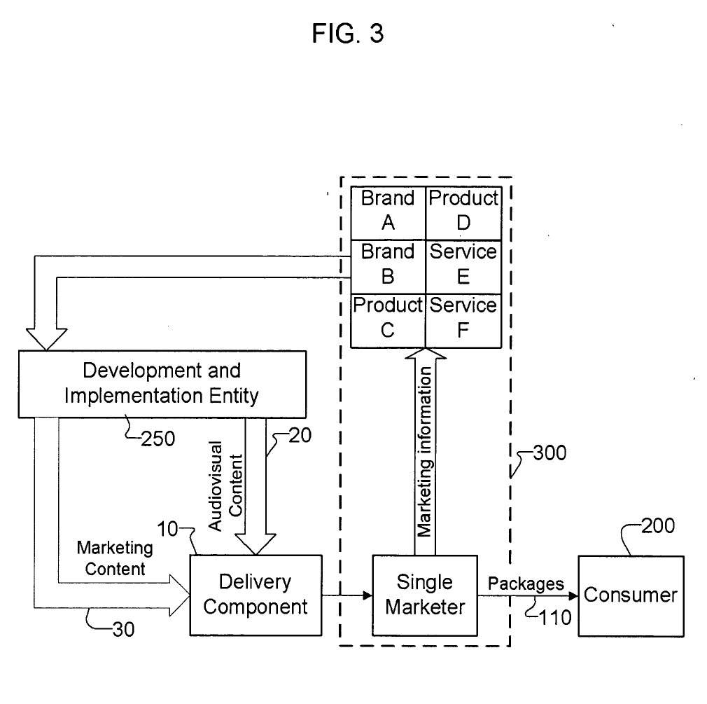

The term “Marketers” refers to any product manufacturer and service provider who may want to develop and implement an embodiment of the invention to meet one or several of its predetermined marketing objectives including, but not limited to: sales growth, brand awareness, new product launch, customer loyalty, crossover sales promotion. Such Marketers will be using the invention to promote one or more products and/or services belonging to one or more of their brands, leading to two anticipated main embodiments of the invention, as described in FIG. 2 and FIG. 3 of this document.

FIG. 2 shows one embodiment of the invention whereby one primary marketer 300 opts not only to develop and implement the embodiment of the invention for its own benefit, but also to commercialize such a newly created channel and its advantages to other non competing third party secondary marketers (marketers 1, 2, 3, and 4). For example, a national retailer 300 will be able to reach consumers 200 by distributing 110 in its stores one or more regular delivery components 10 (such as DVD releases) which would feature audiovisual content 20 and marketing content 30 based on the retailer's marketing objectives as well as on those of its vendors interested in taking advantage of such reach to efficiently promote their own brands (Brand A and Brand B), products (Product C and Product D) and/or services (Service E or Service F).

There may be a separate business entity which, for the purposes of linguistic convenience, may herein be referred to as the “Development and Implementation Entity” 250. Such a separate entity 250 may produce the delivery component 10 or the delivery component 10 may be produced by the primary marketer 300. In the former case, the separate entity 250 may preferably handle the operation of: developing, producing and aggregating the audiovisual content 20 and the marketing content 30 (possibly in partnership with third party entities on an as needed basis), developing and producing the delivery component 10, developing and maintaining the backchannel, handling the commercial interface with primary marketer 300 and secondary marketers 1, 2, 3, and 4.

FIG. 3 shows another embodiment of the invention whereby a single consolidated marketer 300 elects to develop and implement a system according to an embodiment of the invention to serve the strategic and marketing needs of several of its own brands (brands A, B), products (products C, D) and/or services (services E, F). For example, a consumer packaged good company 300 may elect to distribute 110 regular DVD releases 10 to consumers 200 via the packages of several of its product lines, with the DVDs 10 including audiovisual content 20, and marketing content 30 relating to the different product lines.

The separate entity 250 may produce the marketing content 30 based on marketing information provided by the marketer 300 with respect to the desired brands, products, and/or services A-F. The following tasks may advantageously be handled by separate entity 250: developing, producing and aggregating the audiovisual content 20 and marketing content 30, developing and producing the delivery component 10, developing and maintaining the backchannel, or handling the interface between the different brands/product lines A-F of the consolidated marketer 300.

### MORE DETAILED DESCRIPTION

Referring now to FIG. 1, there is depicted in simplified form a method 100 according to one embodiment of the invention. In this method, a distribution operation 110 includes the provision of a delivery component 10 to a consumer 200.

In one embodiment, the delivery component 10 is a physical thing, such as a DVD or other physical things as already described above. When the delivery component 10 is a physical thing, the distribution operation 110 is performed, for example, by mailing the delivery component 10 to the consumer 200. An alternative distribution operation 110 provides the delivery component 10, for example, near the checkout counter at a merchant site, where the interested consumer 200 may obtain the delivery component 10. Yet another alternative distribution operation 110 provides the delivery component 10 as an attachment to a product. The consumer 200 purchasing the product receives the delivery component 10 because the delivery component 10 is attached to the product.

In another embodiment, the delivery component 10 is provided via an online connection.

By way of explanation, and not for the sake of limitation, let it be assumed for the present that the distribution operation 110 is made with respect to a delivery component 10 that is a physical thing, such as a DVD.

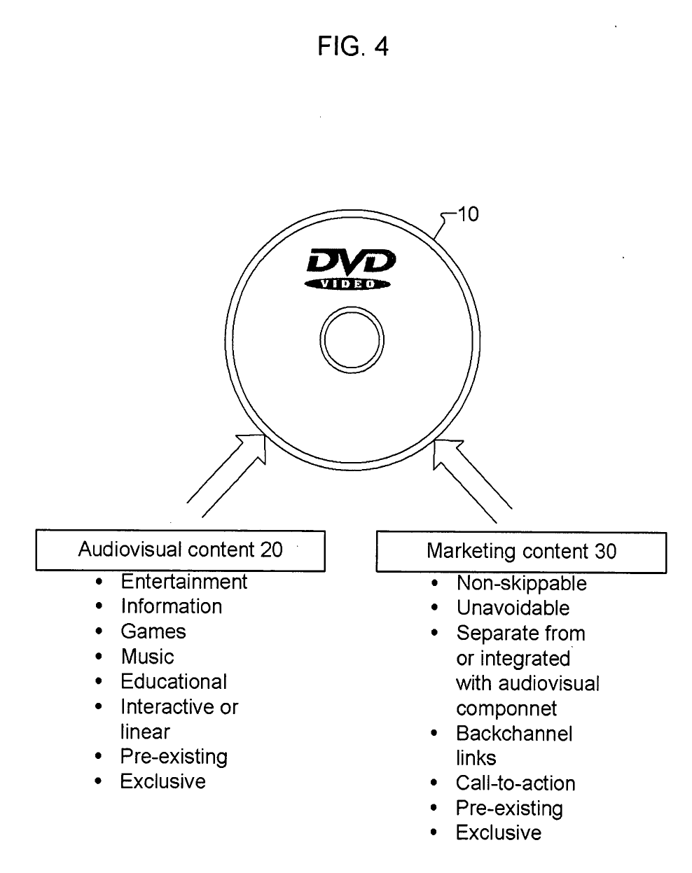

FIG. 4 shows the delivery component 10 being described in the present example. Delivery component 10 has audiovisual content 20 having, for example, entertainment such as an episode of a program, information such as a review of recent developments in a given field, games such as video games, or music such as music videos.

Delivery component 10 also has marketing content 30. As indicated, it is preferable that the marketing content 30 be non-skippable if the marketing content 30 is separate from the audiovisual content 20, as is the case with advertisements. This is easily accomplished in conventional DVD technology, and any manner of making marketing content 30 non-skippable may be acceptable depending on the circumstances. This feature avoids the current phenomenon of consumers recording programs with recorders such as TiVo, and skipping the advertisements.

The marketing content 30 may be made unavoidable as well, by being integrated into the audiovisual content 20. For example, the actors in the audiovisual content 20 can wear the marketer's apparel, use the marketer's products, refer to the marketer's store, or engage in activities that involve the marketer's services.

The delivery component 10 may include links to access the backchannel. The backchannel has been discussed above, but the discussion of this example will continue with an illustration of a simple backchannel arrangement.

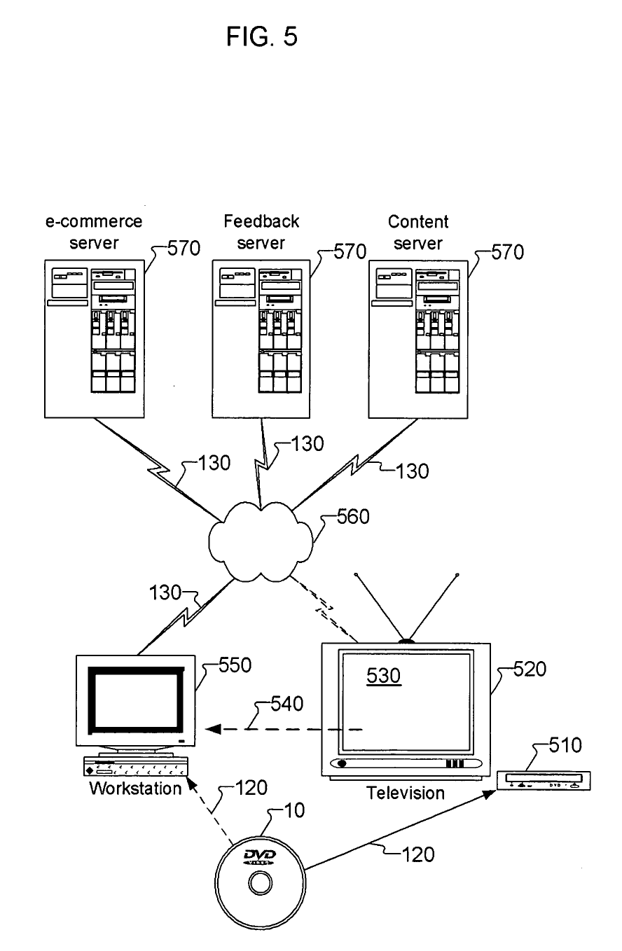

In FIG. 5, the delivery component 10 (still a DVD in this example) may be viewed 120 by the consumer by playing with a suitable device 510 such as a DVD player. The playing device 510 may display the audiovisual content 20 and the marketing content 30 on a display device 520 such as a television set. The display device 520 may provide encouragement to a consumer to visit a particular website by displaying the link information 530.

The consumer may enter the link information 530 by manually entering it 540 into an internet-connected device such as a computer workstation 550. If the display device 520 has an internet connection, then the link may be followed without the use of the workstation 550.

As an alternative, the delivery component 10 may be viewed 120 by playing it on workstation 550 or any other suitable device. In this instance, the link information 530 is displayed on workstation 550, and it is easy to follow the link.

Whether the link is provided as information that may be manually entered, or is a link that can be activated as if in an internet browser, or is some other means for activating a connection over the backchannel, it will be appreciated that such a facility may be thought of as backchannel connection information.

Following the link opens the backchannel 130 through a communications network 560 such as the internet to a backchannel server 570 such as an e-commerce server for purchasing a desired brand, product, or service (A-F). The connection via the backchannel 130 might lead to a backchannel server 570 such as a feedback server for obtaining inputs from the consumer 200. The backchannel server 570 may likewise be a content server, advantageously employed in an arrangement where the conclusion of the audiovisual content 20 is provided only to consumers 200 that perform predetermined operations such as completing a log-in operation via the backchannel 130. Other types of servers could be provided for the sake of any advantage desired by the marketer 300, such as the collection of consumer information or the like for the sake of such goals as audience measurement, return of investment calculation, consumer data collection, and/or information for customer relationship management in general. In addition, the backchannel connection arrangement could provide links to outside third party on-line locations, thus providing qualified leads to such third parties.

The marketer does not itself provide the communications network, but takes advantage of the presence of such a communications network, and provides the consumer with not only the backchannel connection information but puts in place the server or servers 570 with the anticipation that consumers will follow the links described in the backchannel connection information. To put it another way, the marketer 300 (or separate entity 250, as desired) provides a backchannel connection arrangement (i.e., the servers 570) correlated to the backchannel connection information (i.e., set up so that following the links brings the user into communication with the servers 570).

Although the communications network 560 has been described as the internet, it will be appreciated that the network may include cellular networks, satellite networks, cable TV networks, or any similar communications network hereafter developed.

Finally, in the present example, the audiovisual content 20 provided on the delivery component 10 is preferably only one of an episodic series of such content. For example, one might think of an entertainment series such as the popular television programs “Friends,” “Cheers,” or “24,” being provided via only the audiovisual content 20 of a weekly-released or monthly-released DVD as a delivery component 10. The series, in one embodiment, is available exclusively on the delivery component, and is thus unavailable through any over-the-air broadcast, any cablecast, any internet source, or any other channel; the entertainment series is available only via the new direct channel (i.e., through obtaining and viewing the delivery components 10), and the interest in the series makes obtaining and using the delivery component greatly attractive to consumers 200.

The marketing content 30, made unskippable, would be much more effective than the marketing content of the conventional advertising approach.

It will be recalled that, although physical distribution of the delivery component is used extensively in the above examples, other means of distribution may be employed without departing from the scope and spirit of the invention. Likewise, although the audiovisual content has been described as including exclusive audiovisual content, some non-exclusive audiovisual content may be included as well without departing from the scope and spirit of the invention. Furthermore, although distribution has been discussed in general terms, it will be appreciated that distribution may preferably be limited to only certain targeted consumers, and that such consumers may be selected on the basis of selection criteria such as income, age, responses to interviews, location, or the like.

### CONCLUSION

While the exemplary embodiments provided above are described in sufficient detail to fully understand and implement the invention, it should be understood that other embodiments may be realized and that further changes may be made without departing from the spirit and scope of the invention. Thus the detailed description herein is presented for purposes of illustration only and not of limitation, and the scope and reach of this invention is rather to be construed in terms of the appended claims.

There is claimed:

1. A direct content delivery method intended for directly delivering regular audiovisual and marketing content to consumers, comprising:
regularly providing a delivery component having marketing content, backchannel connection information, and exclusive audiovisual content;
directly physically distributing said delivery component to consumers; and
providing a backchannel connection arrangement correlated to the backchannel connection information.

2. A direct content delivery method intended for directly delivering regular audiovisual and marketing content to consumers, comprising:
regularly providing a delivery component having marketing content, backchannel connection information, and exclusive audiovisual content;
directly electronically distributing said delivery component to consumers; and
providing a backchannel connection arrangement correlated to the backchannel connection information;
wherein the exclusive audiovisual content includes at least part of an episode of a series of episodes of an audiovisual program available exclusively via a plurality of said delivery component.

3. The method as set forth in claim 1, wherein said delivery component is one of: a DVD-Video disc, a DVD-Audio disc, a DVD-ROM, a CD-ROM, a CD, an SVCD, a VCD, a CVD, an HD-DVD, a Blu-Ray Disc, and a UMD.

4. The method as set forth in claim 2, wherein said distributing is performed via one of DSL, wireless, CATV, digital cable, satellite, and third generation wireless telephony.

5. The method as set forth in claim 1, wherein said distributing comprises one of in-store distribution, distribution with a packaged good, and mail.

6. The method as set forth in claim 1 or claim 2, wherein the marketing content is from only one single marketer.

7. The method as set forth in claim 1 or claim 2, wherein only one primary marketer controls said distribution of said delivery component, and wherein a plurality of marketers control said marketing content.

8. The method as set forth in claim 1 or claim 2, where in said backchannel connection arrangement includes one of forums, chat functions, interactive games, contest participation, quizzes, log-in forms, newsgroups, informative content, educational content, entertaining content, and peer-to-peer.

9. The method as set forth in claim 1 or claim 2, further comprising encouraging said consumers to access said backchannel arrangement by providing one of a reward program, a contest, a prize, a game, and information.

10. The method as set forth in claim 1 or claim 2, further comprising encouraging said consumers to share the delivery component, with other persons, by providing one of a reward program, a contest, a prize, a game, and information.

11. The method as set forth in claim 1 or claim 2, wherein the providing of the delivery component is performed at least in part by a separate development and implementation entity.

12. The method as set forth in claim 1 or claim 2, wherein the providing of the delivery component is performed by only a single marketer.

13. The method as set forth in claim 1 or claim 2, wherein said audiovisual content includes one or more of video, still images, text, and sound.

14. The method as set forth in claim 1 or claim 2, wherein said audiovisual content includes interactive content.

15. The method as set forth in claim 1 or claim 2, wherein said marketing content is not skippable.

16. The method as set forth in claim 1 or claim 2, wherein said marketing content includes an electronic commerce platform allowing consumers to directly buy a product or service.

17. The method as set forth in claim 1 or claim 2, wherein the marketing content is integrated into the audiovisual content.

18. The method as set forth in claim 1, wherein the exclusive audiovisual content includes at least part of an episode of a series of episodes of an audiovisual program available exclusively via a plurality of said delivery component.

19. A direct marketing channel, comprising:
a backchannel connection arrangement; and
a series of delivery components, each delivery component of the series having marketing content, backchannel connection information, and exclusive audiovisual content;
wherein:
the backchannel connection arrangement is correlated to the backchannel connection information;
the exclusive audiovisual content in the series of delivery components constitutes a series of episodes of an audiovisual program available exclusively via the series of delivery components; and
the delivery components are directly physically distributed to consumers.

20. The direct marketing channel as set forth in claim 19, wherein said backchannel connection arrangement provides links to outside third party on-line locations.

21. The direct marketing channel as set forth in claim 19, wherein said backchannel connection arrangement collects consumer information.

22. The direct marketing channel as set forth in claim 19, wherein the delivery components are directly physically distributed to only targeted consumers.

23. The direct marketing channel as set forth in claim 19, wherein the marketing component comprises one or more of advertising spots, programming sponsorship, infomercials, telescopic advertisements, and product placements.

24. The direct marketing channel as set forth in claim 19, wherein said channel is independent of other existing third party media but supported by a communication plan covering one or more of said third party media.
